(19) United States
(12) Patent Application Publication
(10) Pub. No.: US 2016/0233581 A1
(43) Pub. Date: Aug. 11, 2016

(54) ELECTRONIC DEVICE INCLUDING MULTIBAND ANTENNA USING PERSISTENT CONDUCTIVE BORDER

(71) Applicant: Samsung Electro-Mechanics Co., Ltd., Suwon-si (KR)

(72) Inventors: Nam Ki KIM, Suwon-si (KR); Jun Seung YI, Suwon-si (KR); Young Min CHEON, Suwon-si (KR)

(73) Assignee: Samsung Electro-Mechanics Co., Ltd., Suwon-si (KR)

(21) Appl. No.: 15/019,243

(22) Filed: Feb. 9, 2016

(30) Foreign Application Priority Data
Feb. 11, 2015 (KR) 10-2015-0021176
Dec. 15, 2015 (KR) 10-2015-0179325

(51) Int. Cl. H01Q 5/10; H04M 1/02; H01Q 9/04; H01Q 1/48; H01Q 1/52

(52) U.S. Cl. CPC H01Q 5/10; H01Q 1/48; H01Q 1/526; H01Q 9/04; H04M 1/026

(57) ABSTRACT

An electronic device includes a board, a circuit unit, a feed terminal, a ground, and a conductive border member. The board is embedded within a housing. The circuit unit is disposed on the board, and the feed terminal is connected to the circuit unit. The ground is disposed on the board, and the conductive border member is configured to enclose the housing and includes a first connection terminal connected to the feed terminal, a second connection terminal connected to the ground, a first antenna member configured to provide a first signal path between the first connection terminal and the second connection terminal, and a second antenna member continuously arranged with the first antenna member to form a closed loop and configured to provide a second signal path, different from the first signal path, between the first connection terminal and the second connection terminal.

### CROSS-REFERENCE TO RELATED APPLICATION

This application claims the benefit under 35 U.S.C. 119(a) of Korean Patent Application No. 10-2015-0021176 filed on Feb. 11, 2015 and 10-2015-0179325 filed on Dec. 15, 2015, in the Korean Intellectual Property Office, the entire disclosure of which is incorporated herein by reference.

### BACKGROUND

1. Field

The following description relates to an electronic device including a multiband antenna using a persistent conductive border.

2. Description of Related Art

The popularity of metal designs has gradually grown in portable terminals such as smartphones, tablets, game consoles, televisions, and other electronic devices. Interest in metal designs has increased in terms of improving the aesthetics of an outward exterior and internal rigidity of the portable terminal.

As an example, a metal border is configured in terms of improving the outward exterior of the portable terminal, and a conductor frame is embedded within the portable terminal to provide internal rigidity.

Recently, research has been conducted by portable terminal manufacturers to develop technology using metal borders as antenna portions using metal designs.

As an example, in existing portable devices using the metal borders as a portion of the antenna, a gap is formed by removing a portion of a conductor of the metal border exposed externally, and an end portion of the metal border segmented by the gap is used as the antenna.

However, the design exterior may be undesirable due to the segmentation of the metal border, and a yield may be low in a metal-working process.

In another example, a portable terminal in which antenna performance is implemented without segmenting the metal border has been developed. However, in such portable terminal, in a case in which a portion of the metal border is connected to an internal main antenna, wireless performance is deteriorated because the internal main antenna performs a main radiation function. As a result, communications quality is deteriorated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided an electronic device, including: a board embedded within a housing; a circuit unit disposed on the board; a feed terminal connected to the circuit unit; a ground disposed on the board; and a conductive border member configured to enclose the housing and including a first connection terminal connected to the feed terminal, a second connection terminal connected to the ground, a first antenna member configured to provide a first signal path between the first connection terminal and the second connection terminal, and a second antenna member continuously arranged with the first antenna member to form a closed loop and configured to provide a second signal path, different from the first signal path, between the first connection terminal and the second connection terminal.

The electronic device may also include a shielding conductor partially electromagnetically coupled to the conductive border member in order to improve efficiency of an antenna.

The first antenna member may form a ring-shaped closed loop with the second antenna member.

The first antenna member may have an electrical length different from an electrical length of the second antenna member.

The first antenna member may form a first band current mode, and the second antenna member may form a second band current mode different from the first band current mode.

At least one of the first antenna member and the second antenna member may output resonance modes.

The conductive border member may be coupled to the shielding conductor.

In accordance with another embodiment, there is provided an electronic device, including a feed terminal connected to a circuit unit disposed on a board; a ground disposed on the board; a conductive border member configured to enclose a housing of the electronic device and including a first connection terminal connected to the feed terminal and a second connection terminal connected to the ground; and a shielding conductor configured to enclose the conductive border member to shield electromagnetic waves generated in the electronic device, wherein the conductive border member further includes a first antenna member configured to provide a first signal path between the first connection terminal and the second connection terminal, and a second antenna member continuously arranged with the first antenna member to form a closed loop and configured to provide a second signal path, different from the first signal path, between the first connection terminal and the second connection terminal.

The shielding conductor may be partially electromagnetically coupled to the conductive border member.

The first antenna member may form a ring-shaped closed loop with the second antenna member.

The first antenna member may be an electrical length different from an electrical length of the second antenna member.

The first antenna member may form a first band current mode, and the second antenna member may form a second band current mode different from the first band current mode.

At least one of the first antenna member and the second antenna member may output resonance modes.

The conductive border member may be coupled to the shielding conductor.

In accordance with an embodiment, there is provided an electronic device, including: a feed terminal connected to a circuit unit of a board; a ground disposed on the board, opposite to the feed terminal; a first connection terminal connected to the feed terminal; a second connection terminal connected to the ground; and antenna members disposed between the first connection terminal and the second connection terminal, wherein one of the antenna members provides a first signal path along a portion of an outer edge of a housing of the electronic device, and another of the antenna members, continuously arranged with the one of the antenna members, provides a second signal path along another portion of the outer edge of the housing of the electronic device, and the first and the second signal paths are different from each other.

The electronic device may also include a shielding conductor configured to enclose the outer edge of the electronic device and the antenna members, and to be spaced apart from the board by a predetermined interval.

A region between the shielding conductor and the antenna members may be a non-metal region and is filled with a non-metal material.

A current signal provided through the feed terminal of the circuit unit may flow to the ground of the board, through the one of the antenna members in the first signal path.

Another current signal provided through the feed terminal of the circuit unit may flow to the ground unit of the board, through the other of the antenna members in the second signal path.

The one of the antenna members may form a first band current mode, and the other of the antenna members forms a second band current mode, different from the first band current mode.

Other features and aspects will be apparent from the following detailed description, the drawings, and the claims.

### BRIEF DESCRIPTION OF DRAWINGS

These and/or other aspects will become apparent and more readily appreciated from the following description of the embodiments, taken in conjunction with the accompanying drawings in which:

FIG. 1 is a perspective view illustrating an exterior of an electronic device, according to an embodiment;

FIG. 2 is a view illustrating a first structure of an electronic device including a multiband antenna, according to an embodiment;

FIG. 3 is a view illustrating a second structure of the electronic device including a multiband antenna, according to an embodiment;

FIG. 4 is an exploded perspective view illustrating portions of a structure of the electronic device including a multiband antenna, according to an embodiment;

FIG. 5 is an exploded perspective view illustrating portions of a structure of the electronic device including a multiband antenna, according to an embodiment;

FIG. 6 is a lateral cross-sectional view of the electronic device including a multiband antenna, according to an embodiment;

FIGS. 7A and 7B are, respectively, a front view and a rear view of the electronic device, according to an embodiment;

FIG. 8 is a view illustrating signal paths in the electronic device, according to an embodiment;

FIG. 9 is an equivalent circuit diagram of the electronic device including a multiband antenna, according to an embodiment;

FIGS. 10A through 100 are views illustrating a resonance concept and signal excitation, according to an embodiment; and

FIG. 11 is view illustrating frequency characteristics of a multiband antenna, according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless otherwise defined, all terms, including technical terms and scientific terms, used herein have the same meaning as how they are generally understood by those of ordinary skill in the art to which the present disclosure pertains. Any term that is defined in a general dictionary shall be construed to have the same meaning in the context of the relevant art, and, unless otherwise defined explicitly, shall not be interpreted to have an idealistic or excessively formalistic meaning. Identical or corresponding elements will be given the same reference numerals, regardless of the figure number, and any redundant description of the identical or corresponding elements will not be repeated. Throughout the description of the present disclosure, when describing a certain relevant conventional technology is determined to evade the point of the present disclosure, the pertinent detailed description will be omitted. Terms such as “first” and “second” can be used in describing various elements, but the above elements shall not be restricted to the above terms. The above terms are used only to distinguish one element from the other. In the accompanying drawings, some elements may be exaggerated, omitted or briefly illustrated, and the dimensions of the elements do not necessarily reflect the actual dimensions of these elements.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

An electronic device including a multiband antenna, according to an embodiment, includes a board and a conductive border member, in which a feed terminal of a circuit unit mounted on the board is connected to one point of the conductive border member and another point of the conductive border member is connected to a ground of the board. Therefore, a signal current in the circuit unit flows through the conductive border member, such that current loops having different frequency bands are formed. As a result, a multiband is supported. In addition, in a case in which a shielding conductor is disposed outwardly of the conductive border member, electromagnetic waves generated in the electronic device may be shielded, such that a specific absorption rate (SAR) is reduced.

This will be described with reference to the accompanying drawings.

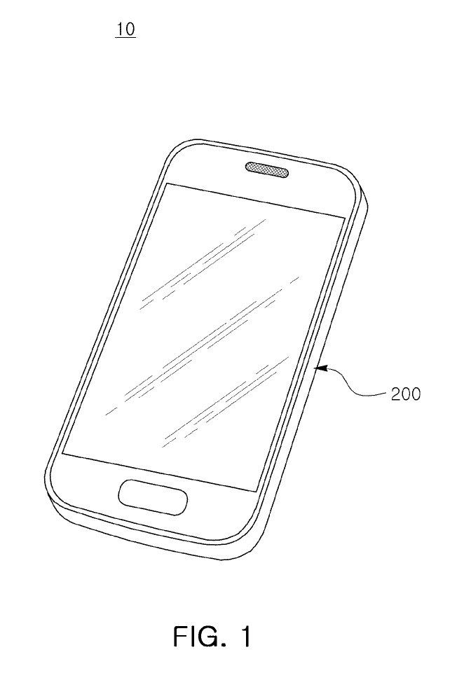

FIG. 1 is a perspective view illustrating an exterior of an electronic device 10, according to an embodiment.

Referring to FIG. 1, the electronic device 10 including a multiband antenna, according to an embodiment, includes a conductive border member 200.

The conductive border member 200 is continuously or persistently disposed along an outer edge of a housing of the electronic device 10, thereby forming a closed loop. The housing of the electronic device 10 includes a board.

In an embodiment, the conductive border member 200 is formed of a metal, such as aluminum, steel, titanium, gold, or sterling silver, having a ring shape. However, the conductive border member 200 is not particularly limited to a shape or a structure as long as the conductive border member 200 encloses an outer side of the electronic device and is formed of a conductive material.

In addition, the electronic device, according to an embodiment, includes a communications terminal needing an antenna. The electronic device is, for example, a smartphone, a navigation device, a tablet, a television, or a game console.

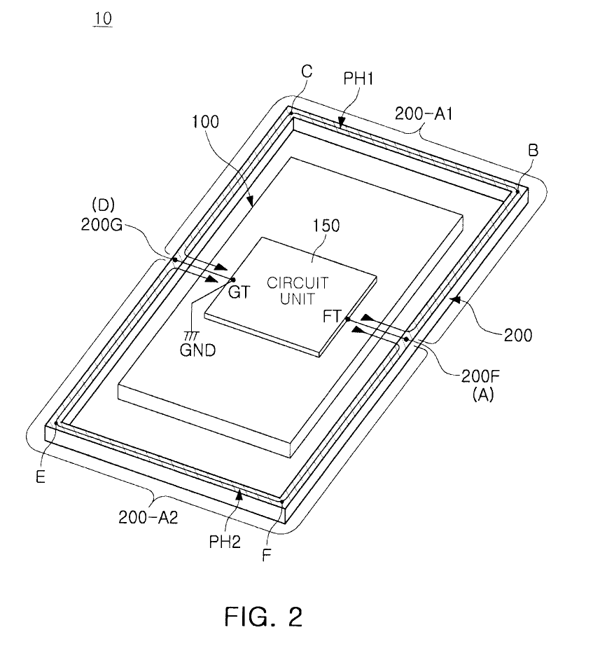

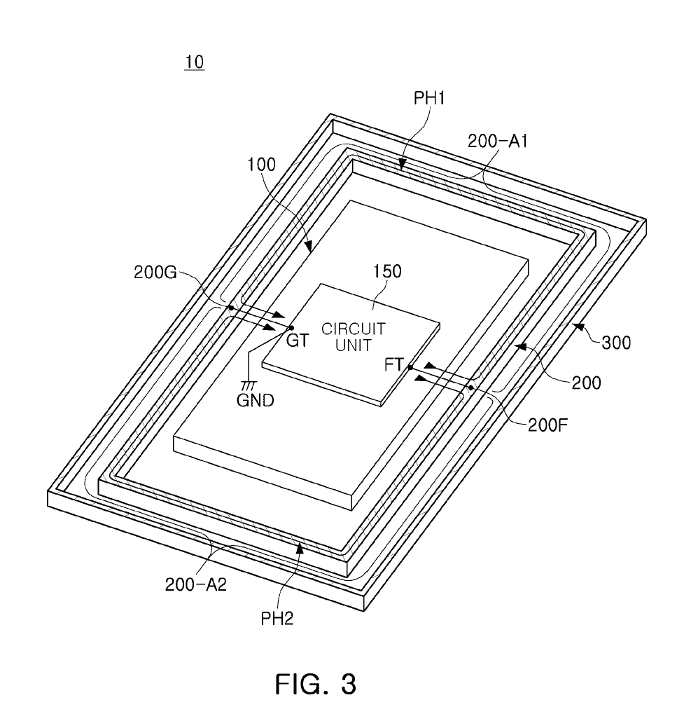

FIG. 2 is a view illustrating a first structure of an electronic device 10 including a multiband antenna, according to an embodiment. FIG. 3 is a view illustrating a second structure of the electronic device 10 including a multiband antenna, according to an embodiment.

Referring to FIGS. 2 and 3, the electronic device 10 including a multiband antenna, according to an embodiment, includes a board 100, a circuit unit 150, a feed terminal FT, a ground GND, and the conductive border member 200. The circuit unit 150 and the ground GND are disposed on the board 100.

The feed terminal FT is electrically connected to the circuit unit 150 of the board 100 and is embedded within the electronic device 10 to provide a signal current from the circuit unit 150 to the conductive border member 200.

The ground GND is disposed on the board 100, and is electrically connected to a ground terminal GT of the circuit unit 150. In an example, the ground terminal GT, which is a ground terminal of the circuit unit 150, is defined as a terminal electrically connected to the ground GND of the board 100. The ground GND is formed in a region of the board 100 from which a space, in which the circuit unit 150 and circuit lines are disposed, is excluded.

In addition, the conductive border member 200 is disposed along an outer edge of the housing of the electronic device 10, as described above, and includes a first connection terminal 200F connected to the feed terminal FT and a second connection terminal 200G connected to the ground GND.

The circuit unit 150 includes various circuits and structural components needed to perform certain functions required by the electronic device. Also, circuit lines are electrically connecting the circuits and the structural components to each other, and are electrically connected to the ground GND of the board 100.

In an example, the conductive border member 200 includes a first antenna member 200-A1 and a second antenna member 200-A2 that are physically continuous or continuously arranged with each other.

In one embodiment, the first antenna member 200-A1 is disposed between the first connection terminal 200F and the second connection terminal 200G along a portion of the outer edge of the housing of the electronic device 10, and provides a first signal path PH1.

The second antenna member 200-A2, in turn, is disposed between the first connection terminal 200F and the second connection terminal 200G along another portion of the outer edge of the housing of the electronic device 10, and provides a second signal path PH2, which is different from the first signal path PH1.

The first antenna member 200-A1 is physically continuous with the second antenna member 200-A2 to form a ring-shaped closed loop. Although the configuration of FIG. 2 illustrates two points, the first and the second connection terminals 200G and 200F, respectively, as defining points of the first antenna member 200-A1 and the second antenna member 200-A2, a person skill in the art will appreciate that additional connection terminals may be included between the first and the second connection terminals 200G and 200F to further define additional antenna members.

Referring to FIG. 3, the electronic device 10 including a multiband antenna may further include a shielding conductor 300.

The shielding conductor 300 encloses side surfaces of the conductive border member 200, outside of the conductive border member 200, to shield electromagnetic waves generated in the electronic device.

In addition, the shielding conductor 300 encloses an outer edge of side surfaces of the electronic device 10 and the conductive border member 200.

The shielding conductor 300 is spaced apart from the board 100 by a predetermined interval, and, in one embodiment, has a shielding ring shape that blocks the electromagnetic waves generated in the electronic device 10. In an example, the shielding conductor 300 partially includes a conductive material and has a ring shape. The shielding conductor 300 may be made of a metal.

In addition, the shielding conductor 300 is, at least, partially electromagnetically coupled to the conductive border member 200 in order to improve efficiency of an antenna. In this case, the shielding conductor 300 serves to radiate the signals from the antenna or as a radiator of the antenna together with the conductive border member 200 to improve the efficiency of the antenna.

As described above, the shielding conductor 300 is disposed outside of the conductive border member 200 to be spaced apart from the conductive border member 200 at a predetermined interval. In an embodiment, the predetermined interval (for example, a filling gap) is about 1 to 2 mm, but is not limited thereto.

In one embodiment, a region between the shielding conductor 300 and the conductive border member 200 is a non-metal region and is filled with a non-metal material. Therefore, the predetermined interval may be referred to as the filling gap. In an example, the filling gap is a capacitance in an electrical equivalent circuit.

Furthermore, although the shielding conductor 300 and the conductive border member 200 are not physically connected to each other, a signal transferred from the board 100 to the conductive border member 200 are excited in the shielding conductor 300 through electromagnetic coupling. Therefore, the shielding conductor 300 and the conductive border member 200 may also be electromagnetically connected to each other.

In addition, the non-metal region having the predetermined interval, a filling gap section, may be filled with polycarbonate (PC), acrylonitrile butadiene styrene (ABS), or glass fiber (GF) by injection-molding in an insert scheme as an example. The filling gap, the non-metal region as described above, provides a radiation space and a coupling space from the outermost shielding conductor to improve an antenna efficiency.

In an embodiment, a structure to electrically connect the conductive border member 200 and the board 100 to each other may be at least one of mechanical coupling members such as a C-clip, an L-clip, a screw, or similar mechanisms.

In addition, the board 100 is not particularly limited, but may be at least one of a printed circuit board (PCB), a flexible printed circuit board (FPCB), a rigid printed circuit board, and a rigid-flexible printed circuit board.

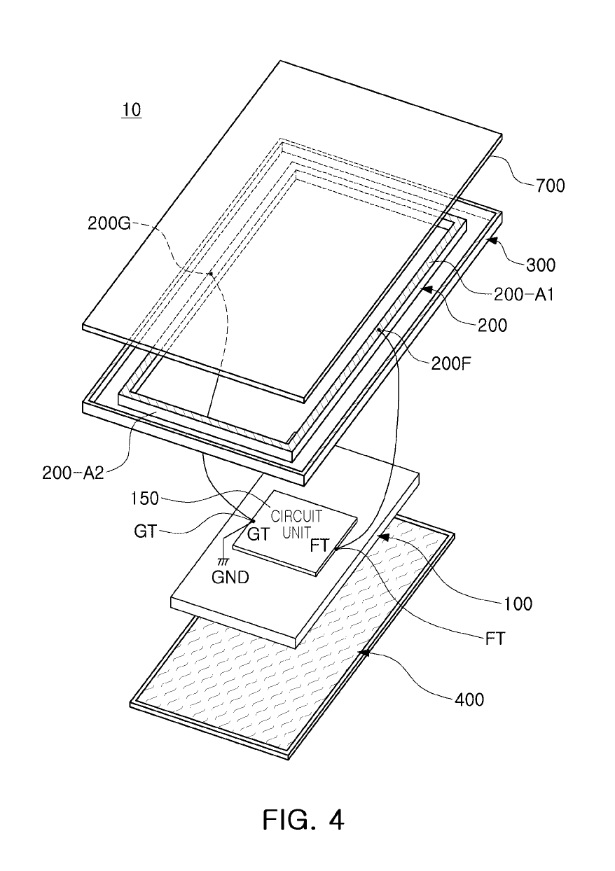

FIG. 4 is an exploded perspective view illustrating portions of a structure of the electronic device 10 including a multiband antenna, according to an embodiment.

Referring to FIG. 4, the electronic device including a multiband antenna, according to an embodiment, includes the board 100, the conductive border member 200, and the shielding conductor 300, as described above, and further includes a cover 700 disposed on a rear surface of the electronic device 10 and a display panel 400 disposed on a front surface of the electronic device 10. The cover 700 protects internal elements of the electronic device 10 and is, for example, a rear cover or a back cover.

In addition, in the electronic device 10, the conductive border member 200 is disposed on the same layer as a layer on which the board 100 is disposed, as illustrated in FIGS. 2 and 3. However, alternatively, the conductive border member 200 is disposed on a different layer to the layer on which the board 100 is disposed.

As an example, a position of the conductive border member 200 is not particularly limited, as long as the conductive border member 200 is electrically connected to the board 100.

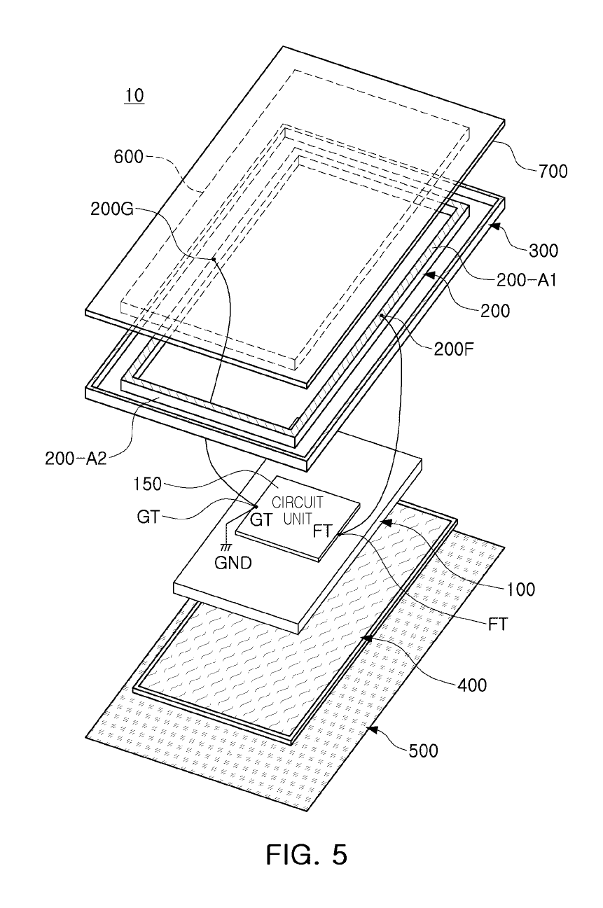

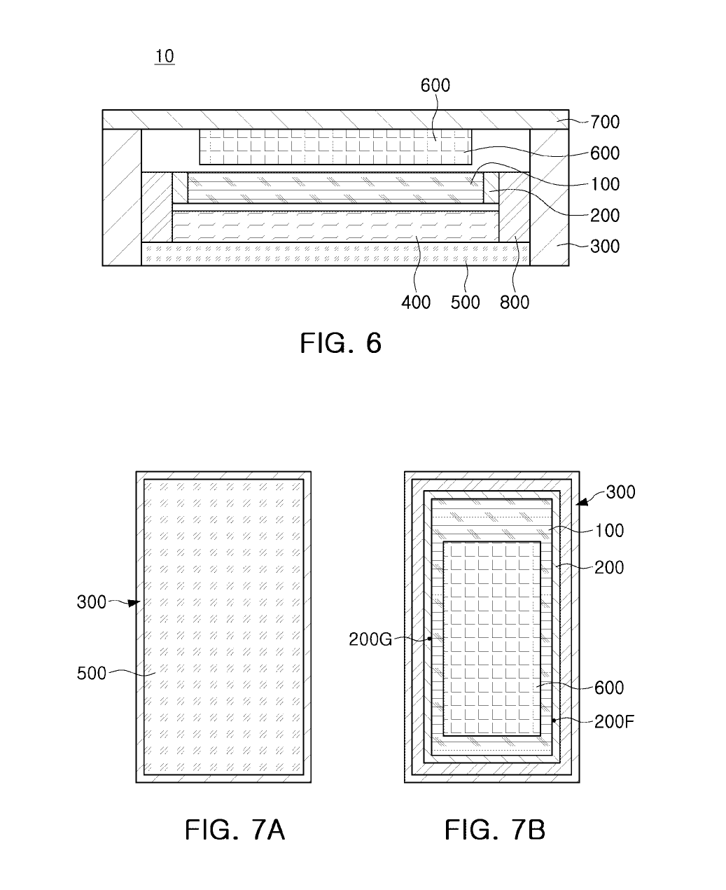

FIG. 5 is an exploded perspective view illustrating portions of a structure of the electronic device 10 including a multiband antenna, according to an embodiment. FIG. 6 is a lateral cross-sectional view of the electronic device 10 including a multiband antenna, according to an embodiment.

Referring to FIGS. 5 and 6, the electronic device 10 including a multiband antenna, according to an embodiment, includes the board 100, the conductive border member 200, the shielding conductor 300, the display panel 400, and the cover 700, as described above, and further includes a battery cell 600 disposed between the cover 700 and the board 100 of the electronic device 10 and a touch screen panel 500 on the front surface of the electronic device 10.

The battery cell 600 is a power supply unit to supply power to the electronic device, is not particularly limited as long as it is a device that supplies power to the electronic device. For example, the battery cell 600 is a replaceable battery cell or an embedded power supply apparatus that is not replaced. In an example, the power supply device has a rechargeable structure or a solar cell structure.

Referring to FIG. 6, as an example, the touch screen panel 500, the display panel 400, the board 100, the battery cell 600, and the cover 700 are sequentially disposed in the electronic device 10. A person of ordinary skill in the art will appreciate that additional structural elements may be interposed between the touch screen panel 500, the display panel 400, the board 100, the battery cell 600, and the cover 700.

In addition, as an example, the conductive border member 200 encloses outer side surfaces of the board 100. Alternatively, the shielding conductor 300 encloses all of the touch screen panel 500, the display panel 400, the board 100, and the battery cell 600.

Referring to FIGS. 5 and 6, the electronic device 10 is, for example, a terminal supporting a wireless transmission band including a third generation partnership project (3GPP) or a long term evolution (LTE) communications band.

In an example, a disposition or arrangement sequence of the structural components of the electronic device 10 is not limited to a disposition sequence illustrated in FIGS. 5 and 6. That is, as another example, the conductive border member 200 may be disposed to enclose the cover 700, unlike being illustrated in FIG. 6. As described above, a disposition structure of the components of the electronic device is not particularly limited to a specific disposition sequence.

A space between the display panel 500 and the shielding conductor 300 and a space between the board 100 and the shielding conductor 200 may be filled with a filling material, the non-metal material, as described above.

FIGS. 7A and 7B are, respectively, a front view and a rear view of the electronic device 10, according to an embodiment.

FIG. 7A is a front view of the electronic device, according to an embodiment. FIG. 7B is a rear view of the electronic device 10, according to an embodiment.

Referring to FIG. 7A, the touch screen panel 500 and the shielding conductor 300 are viewed on a front surface of the electronic device 10.

Referring to FIG. 7B, when the cover 700 is removed, the battery cell 600, the board 100, the conductive border member 200, and the shielding conductor 300 are viewed on the rear surface of the electronic device 10.

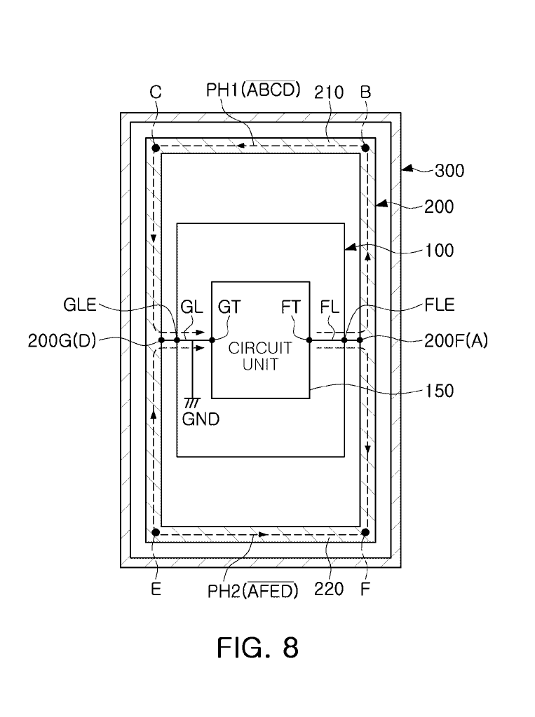

FIG. 8 is a view illustrating signal paths in the electronic device 10, according to an embodiment.

Referring to FIGS. 3 and 8, as described above, the circuit unit 150 of the board 100 is electrically connected to the first connection terminal 200F of the conductive border member 200 through the feed terminal FT. The conductive border member 200 is electrically connected to the ground GND of the board 100 to which the ground terminal FT of the circuit unit 150 is electrically connected, through the second connection terminal 200G.

The first antenna member 200-A1 is disposed along a portion of the outer edge of the housing of the electronic device 10, and provides the first signal path PH1 between the first connection terminal 200F and the second connection terminal 200G.

Therefore, one current signal provided through the feed terminal FT of the circuit unit 150 flows to the ground GND of the board 100 through the first antenna member 200-A1 included in the first signal path PH1. In this case, the current signal flows through the feed terminal FT, passes through a point A, a point B, a point C, and a point D, and then flows to the ground GND of the board 100.

As an example, as illustrated in FIG. 8, the feed terminal FT of the circuit unit 150 is connected to a feeding line FL formed on the board 100, and an end portion FLE of the feeding line FL is electrically connected to the first connection terminal 200F of the conductive border member 200.

In addition, the ground terminal GT of the circuit unit 150 is connected to a ground line GL formed on the board 100, and an end portion GLE of the ground line GL is electrically connected to the second connection terminal 200G of the conductive border member 200. In an example, the ground line GL is included in the ground GND of the board.

Furthermore, the second antenna member 200-A2 is disposed along another portion of the outer edge of the housing of the electronic device 10, and provides the second signal path PH2 different from the first signal path PH1 between the first connection terminal 200F and the second connection terminal 200G.

Therefore, another current signal provided through the feed terminal FT of the circuit unit 150 flows to the ground GND of the board 100 through the second antenna member 200-A2 included in the second signal path PH2. In this case, the current signal flows through the feed terminal FT, passes through the point A, a point F, a point E, and the point D, and then flows to the ground GND of the board 100.

The first antenna member 200-A1 has an electrical length different from that of the second antenna member 200-A2.

Therefore, the first antenna member 200-A1 forms a first band current mode, and the second antenna member 200-A2 forms a second band current mode, different from the first band current mode.

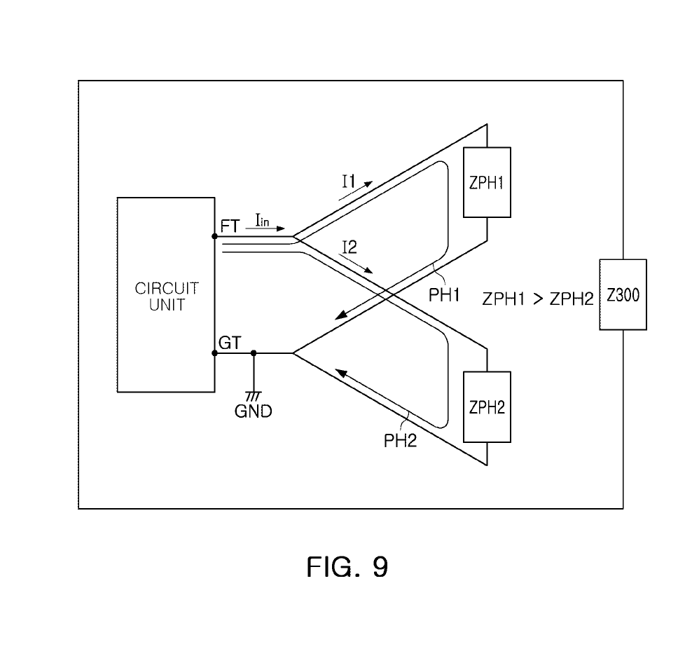

FIG. 9 is an equivalent circuit diagram of the electronic device 10 including a multiband antenna, according to an embodiment.

Referring to FIGS. 8 and 9, when a current signal is applied from the circuit unit 150 of the board 100 through the feed terminal (the point A), the current signal flows to the ground GND of the board 100, which is electrically connected to the point D through the points A, B, C, and D of the first antenna member 200-A1 of the conductive border member 200. A first loop includes an impedance ZPH1 and corresponds to one resonance mode that is formed depending on the flow of the current signal.

In addition, the current signal provided through the feed terminal FT (the point A) flows to the ground GND of the board 100 electrically connected to the point D through the points, A, F, E, and D of the second antenna member 200-A2 of the conductive border member 200. A second loop includes an impedance ZPH2 and corresponds to another resonance mode that is formed depending on the flow of the current signal.

In an embodiment, Z300 is an equivalent impedance of the shielding conductor 300.

As described above, a first current I1 of an input current Iᵢₙ flows through the first loop ZPH1, such that a first current mode is formed. A second current I2 of the input current Iᵢₙ flows through the second loop ZPH2, such that a second current mode is formed.

In an embodiment, an input impedance Zᵢₙ is an impedance for the first loop ZPH1 and the second loop ZPH2, and because the first loop and the second loop are connected to each other in parallel, the input impedance Zᵢₙ is represented by Equation 1.

In addition, the shielding conductor 300 is represented by a metal body impedance Zmetalbody. However, because the shielding conductor 300 is spaced apart from the conductive border member 200 by the filling gap, the shielding conductor 300 may be considered to not have an influence on the input impedance Zᵢₙ.

$$Input Impedance ( Zin ) = \frac{1}{1 / ZPH 1 + 1 / ZPH 2} \qquad [ Equation 1 ]$$

As described above, the first loop ZPH1 and the second loop ZPH2 are different from each other and are formed through the conductive border member 200, such that multi-resonance is formed by the conductive border member 200. Therefore, the antenna, according to an embodiment, may be operated as a multiband antenna.

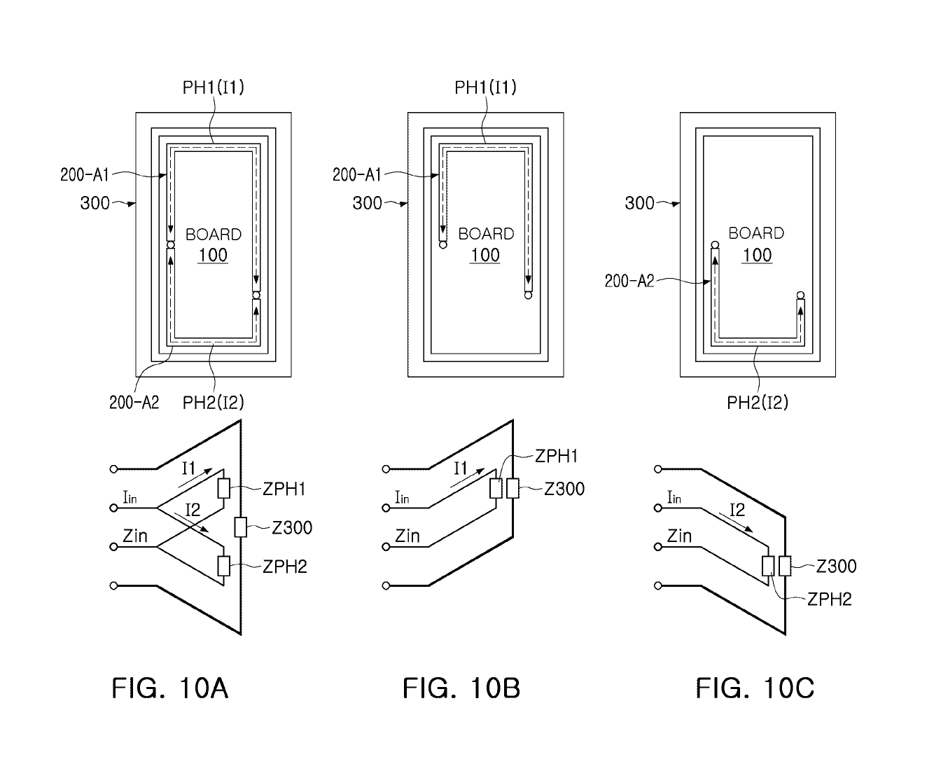

FIGS. 10A through 100 are views illustrating a resonance concept and signal excitation, according to an embodiment.

FIG. 10A is a view of a structure in which a signal is transmitted to the shielding conductor 300 by a structure in which the first loop ZPH1 and the second loop ZPH2, formed in the conductive border member 200, are connected to each other in parallel. FIG. 10B is a view of a structure in which a signal is transmitted to the shielding conductor 300 only by the first loop ZPH1. In addition, FIG. 100 is a view of a structure in which a signal is transmitted to the shielding conductor 300 only by the second loop ZPH2.

Referring to FIGS. 8 through 10C, in the electronic device 10 including the board 100, the conductive border member 200, and the display panel 400, the shielding conductor 300 formed of a conductive material is disposed externally to the electronic device 10 in order to reduce a specific absorption rate (SAR). In this configuration, the conductive border member 200 is disposed on the board 100 of the electronic device 10, the circuit unit 150 of the board 100 is connected to the conductive border member 200 through the feed terminal FT (point A), and the ground GND of the board 100 is connected to the conductive border member 200 through the second connection terminal 200G. As a result, the conductive border member 200 serves as an antenna forming different current loops that operates as a multiband antenna having a folded loop form.

As an example, when the current signal is applied from the circuit unit 150 of the board 100 through the feed terminal FT (point A), the current signal flows to the ground of the board 100 through the points A, B, C, and D of the conductive border member 200. The current signal also flows through the second connection terminal 200G, the point D. In this example, the first loop ZPH1 (one resonator) is formed depending on the flow of the current signal.

In addition, the current signal flows to the ground of the board 100 through the points A, F, E, and D of the conductive border member 200 and through the second connection terminal 200G, the point D, and the second loop ZPH2 (another resonator) is formed depending on this flow of the current signal. As a result of the first loop ZPH1 and the second loop ZPH2, as described above, the conductive border member 200 forms the multi-resonance and operates as a multiband antenna.

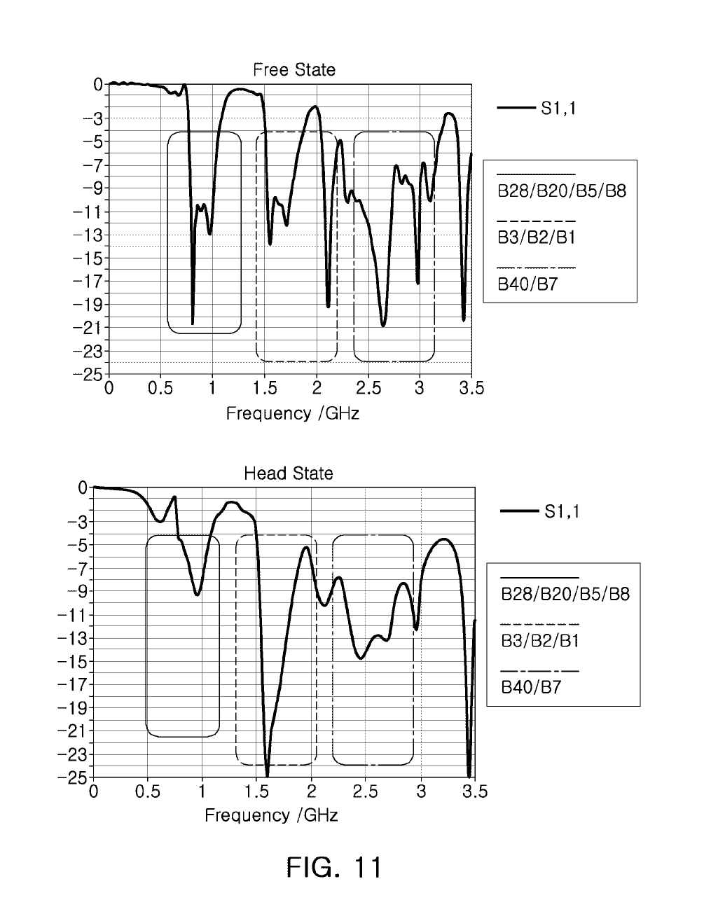

FIGS. 11A and 11B are views illustrating frequency characteristics of a multiband antenna, according to an embodiment.

In FIGS. 11A and 11B, views of return loss [dB] characteristics (S1,1 an S-parameter) representing frequency characteristics to confirm multi-resonance characteristics of a multiband antenna are illustrated.

Referring to FIGS. 11A and 11B, return loss is a ratio between incident power and return power represented in a [dB] unit. In an example, in response to an electrical signal being transmitted and a mismatch point of impedance is present in a transmission system, return of power is generated at the mismatch point, such that a portion of the incident power becomes the return power.

In FIGS. 11A and 11B, a low band (700 to 900 MHz) is grouped and illustrated as B28/B20/B5/B8, a middle band (1710 to 2170 MHz) is grouped and illustrated as B3/B2/B1, and a high band (2300 to 2690 MHz) is grouped and illustrated as B40/B7.

In addition, FIG. 11A is a view illustrating frequency characteristics for a free state (free space) in LTE support bands B1/B2/B3/B4/B5/B8/B20/B28/B40 by the multiband antenna. FIG. 11B is a view illustrating frequency characteristics for a head state (head phantom only) in which a specific absorption rate (SAR) is considered in LTE support bands B1/B2/B3/B4/B5/B8/B20/B28/B40 by the multiband antenna.

Referring to FIGS. 11A and 11B, in response to a condition being satisfied in a case in which return loss is −4 [dB] or less, because the return loss is −4 [dB] or less in each of the LTE support bands B1/B2/B3/B4/B5/B8/B20/B28/B40, as illustrated in FIGS. 11A and 11B, the multiband antenna covers all of at least nine to eleven transmission and reception communications bands.

On the other hand, Comparative Example of total radiated power (TRP), in a case in which the multiband antenna is used in a mobile phone, is represented by Table 1.

In accordance with an embodiment, Table 1 illustrates Comparative Example of TRP of the multiband antenna, according to an embodiment. In an example, the TRP, one of indices indicating radiation performance of the mobile phone, is power that is actually radiated through an antenna of the mobile phone, and is a factor indicating a sum of power actually radiated through the antenna, without considering a direction or a polarization.

When power radiated through the antenna of the mobile phone is ideal, without power being lost, in a case in which conduction power [dBm] is applied, the applied conduction power should be radiated, without modification. However, loss is inevitable in reality or application when considering loss of the antenna due to mismatch and radiation efficient of the antenna.

Therefore, values of TRP performance indices for an antenna structure, as suggested in an embodiment, extracted through a computer simulation are illustrated as Comparative Example of TRP characteristics in Table 1.

TABLE 1

| | | Ferquency [MHz] | | | | | |
|---|---|---|---|---|---|---|---|
| | | 790 | 900 | 1700 | 1900 | 2100 | 2600 |
| Conduction [dBm] | | 33 | 33 | 30 | 30 | 24 | 24 |
| TRP | Free Space | 31.8 | 31.7 | 26.5 | 26.6 | 23.5 | 21.6 |
| [dBm] | Δ | 7.7 | 6.2 | 4.2 | 3.3 | 3.8 | 3.1 |
| | Head state | 24.1 | 25.5 | 22.3 | 23.3 | 19.7 | 18.5 |
| | Δ | 4.4 | 4.3 | 4.9 | 4.3 | 4.3 | 3.3 |
| | Head + Hand state | 19.7 | 21.2 | 17.4 | 19.0 | 15.4 | 15.2 |

Referring to Table 1, TRP characteristic values are denoted by numerical values in consideration of frequency characteristics in each communications band. A delta (Δ) value is a numerical value indicating a relative difference value of each of a free space, a head state, and a head+hand state in order to infer a specific absorption rate.

As shown in Table 1, when viewing 900 MHz as an example, frequency characteristics of the head state are different from those of the free space by Δ(6.2 dBm) and frequency characteristics of the head+hand state are different from those of the head state by Δ(4.3 dBm).

For example, when conduction power of 33 dBm is applied at 900 MHz (low frequency band), TRP characteristic values of each of the free space, the head state, and the head+hand state are 31.7 dBm, 25.5 dBm, and 21.2 dBm.

As illustrated in Table 1, TRP characteristic values, which are radiation performance indices, of the multiband antenna at each of 790 MHz, 900 MHz, 1700 MHz, 1900 MHz, 2100 MHz, and 2600 MHz are 15 dMB or more, are higher than TRP characteristic values compared to a conventional electronic device.

As set forth above, according to an embodiment, in the electronic device having the conductive border member, the multiband antenna that cover a multiband is configured using a persistent conductive border member. That is, because the persistent conductive border member is used, a metal-working process is easily performed, such that a yield is improved. Also, because the conductive border member adjacent to an external surface is used, performance of the antenna is improved.

In addition, in the case in which the shielding conductor is disposed at the outer side of the conductive border member, the electromagnetic waves generated in the electronic device are shielded, such that the specific absorption rate (SAR) is reduced.

The apparatuses, units, modules, devices, and other components illustrated in FIGS. 1 through 9 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An electronic device, comprising:
a board embedded within a housing;
a circuit unit disposed on the board;
a feed terminal connected to the circuit unit;
a ground disposed on the board; and
a conductive border member configured to enclose the housing and comprising
a first connection terminal connected to the feed terminal,
a second connection terminal connected to the ground,
a first antenna member configured to provide a first signal path between the first connection terminal and the second connection terminal, and
a second antenna member continuously arranged with the first antenna member to form a closed loop and configured to provide a second signal path, different from the first signal path, between the first connection terminal and the second connection terminal.

2. The electronic device of claim 1, further comprising:
a shielding conductor partially electromagnetically coupled to the conductive border member in order to improve efficiency of an antenna.

3. The electronic device of claim 1, wherein the first antenna member is forms a ring-shaped closed loop with the second antenna member.

4. The electronic device of claim 1, wherein the first antenna member has an electrical length different from an electrical length of the second antenna member.

5. The electronic device of claim 1, wherein the first antenna member forms a first band current mode, and
the second antenna member forms a second band current mode different from the first band current mode.

6. The electronic device of claim 1, wherein at least one of the first antenna member and the second antenna member outputs resonance modes.

7. The electronic device of claim 2, wherein the conductive border member is coupled to the shielding conductor.

8. An electronic device, comprising:
a feed terminal connected to a circuit unit disposed on a board;
a ground disposed on the board;
a conductive border member configured to enclose a housing of the electronic device and comprising a first connection terminal connected to the feed terminal and a second connection terminal connected to the ground; and
a shielding conductor configured to enclose the conductive border member to shield electromagnetic waves generated in the electronic device,
wherein the conductive border member further comprises
a first antenna member configured to provide a first signal path between the first connection terminal and the second connection terminal, and
a second antenna member continuously arranged with the first antenna member to form a closed loop and configured to provide a second signal path, different from the first signal path, between the first connection terminal and the second connection terminal.

9. The electronic device of claim 8, wherein the shielding conductor is partially electromagnetically coupled to the conductive border member.

10. The electronic device of claim 8, wherein the first antenna member forms a ring-shaped closed loop with the second antenna member.

11. The electronic device of claim 8, wherein the first antenna member has an electrical length different from an electrical length of the second antenna member.

12. The electronic device of claim 8, wherein the first antenna member forms a first band current mode, and
the second antenna member forms a second band current mode different from the first band current mode.

13. The electronic device of claim 8, wherein at least one of the first antenna member and the second antenna member outputs resonance modes.

14. The electronic device of claim 9, wherein the conductive border member is coupled to the shielding conductor.

15. An electronic device, comprising:
a feed terminal connected to a circuit unit of a board;
a ground disposed on the board, opposite to the feed terminal;
a first connection terminal connected to the feed terminal;
a second connection terminal connected to the ground; and
antenna members disposed between the first connection terminal and the second connection terminal,
wherein one of the antenna members provides a first signal path along a portion of an outer edge of a housing of the electronic device, and another of the antenna members, continuously arranged with the one of the antenna members, provides a second signal path along another portion of the outer edge of the housing of the electronic device, and the first and the second signal paths are different from each other.

16. The electronic device of claim 15, further comprising:
a shielding conductor configured to enclose the outer edge of the electronic device and the antenna members, and to be spaced apart from the board by a predetermined interval.

17. The electronic device of claim 16, wherein a region between the shielding conductor and the antenna members is a non-metal region and is filled with a non-metal material.

18. The electronic device of claim 15, wherein a current signal provided through the feed terminal of the circuit unit flows to the ground of the board, through the one of the antenna members in the first signal path.

19. The electronic device of claim 18, wherein another current signal provided through the feed terminal of the circuit unit flows to the ground unit of the board, through the other of the antenna members in the second signal path.

20. The electronic device of claim 19, wherein the one of the antenna members forms a first band current mode, and the other of the antenna members forms a second band current mode, different from the first band current mode.
